(19) United States
(12) Patent Application Publication
(10) Pub. No.: US 2026/0074229 A1
(43) Pub. Date: Mar. 12, 2026

(54) NEGATIVE ELECTRODE FOR ALL-SOLID-STATE BATTERY AND ALL-SOLID-STATE BATTERY INCLUDING THE SAME

(71) Applicant: SAMSUNG SDI CO., LTD., Yongin-si (KR)

(72) Inventors: Haena YIM, Yongin-si (KR); Juhee SOHN, Yongin-si (KR); Hyuksoo SHIN, Yongin-si (KR); Seungman PARK, Yongin-si (KR); Jinhoon YANG, Yongin-si (KR); Haejoo KIM, Yongin-si (KR)

(21) Appl. No.: 19/322,303

(22) Filed: Sep. 8, 2025

(30) Foreign Application Priority Data
Sep. 9, 2024 (KR) 10-2024-0122545

(51) Int. Cl. H01M 4/62; H01M 4/02; H01M 4/04; H01M 4/36

(52) U.S. Cl. CPC H01M 4/628; H01M 4/0404; H01M 4/0426; H01M 4/366; H01M 2004/027

(57) ABSTRACT

A negative electrode and an all-solid-state batteries including the negative electrode are provided. A negative electrode includes a negative electrode current collector, a coating layer comprising carbon and a first metal on the negative electrode current collector, and a functional layer between the negative electrode current collector and the coating layer. The functional layer includes a second metal. Each of the first metal and the second metal includes at least one lithiophilic element selected from among silver (Ag), gold (Au), magnesium (Mg), indium (In), titanium (Ti), gallium (Ga), platinum (Pt), palladium (Pd), silicon (Si), aluminum (Al), bismuth (Bi), tin (Sn), and/or zinc (Zn).

### CROSS-REFERENCE TO RELATED APPLICATION

The present application claims priority to and the benefit of Korean Patent Application No. 10-2024-0122545, filed on Sep. 9, 2024, in the Korean Intellectual Property Office, the entire disclosure of which is incorporated herein by reference.

### BACKGROUND

The present disclosure relates to a negative electrode for an all-solid-state battery and an all-solid-state battery including the negative electrode.

The development of high-energy density and safe batteries has been driven by industrial demands. Recently, an all-solid-state battery that utilizes a solid electrolyte in place of a liquid electrolyte has been suggested. An all-solid-state battery is a battery that is densified through pressing after stacking a positive electrode, a solid electrolyte, and a negative electrode. The all-solid-state battery utilizes the solid electrolyte instead of the liquid electrolyte(s) utilized in comparable rechargeable batteries. As the all-solid-state battery does not utilize a flammable organic dispersion medium (of the liquid electrolyte), the possibility of fire and/or explosion may be significantly reduced, even in the event of a short circuit. Therefore, such an all-solid-state battery may have high stability.

### SUMMARY

One or more aspects of the present disclosure are directed toward a negative electrode for an all-solid-state battery that promotes (e.g., enhances or improves) a substantially uniform growth of a lithium metal layer during charge and discharge and enhances or improves ionic conductivity.

One or more aspects of the present disclosure are directed toward an all-solid-state battery with enhanced or improved electrochemical properties.

Additional aspects will be set forth in part in the description which follows and, in part, will be apparent from the description, or may be learned by practice of the presented embodiments of the disclosure.

In one or more embodiments of the present disclosure, a negative electrode includes a negative electrode current collector; a coating layer including carbon and a first metal on the negative electrode current collector; and a functional layer between the negative electrode current collector and the coating layer. The functional layer includes a second metal. Each of the first metal and the second metal includes at least one lithiophilic element selected from among silver (Ag), gold (Au), magnesium (Mg), indium (In), titanium (Ti), gallium (Ga), platinum (Pt), palladium (Pd), silicon (Si), aluminum (Al), bismuth (Bi), tin (Sn), and/or zinc (Zn). The battery is an all-solid-state battery.

In one or more embodiments of the present disclosure, an all-solid-state battery includes a positive electrode; a negative electrode opposite to the positive electrode; and a solid electrolyte between the positive electrode and the negative electrode. The negative electrode includes a negative electrode current collector; a coating layer on the negative electrode current collector; and a functional layer between the negative electrode current collector and the coating layer. The coating layer includes carbon and a first metal. The functional layer includes a second metal. Each of the first metal and the second metal is a lithiophilic metal. A thickness of the coating layer is greater than a thickness of the functional layer. The thickness of the functional layer is in a range of about 30 nm to about 4 μm.

In one or more embodiments of the present disclosure, a method includes forming (e.g., applying) a functional layer on a first surface of a negative electrode current collector; and forming (e.g., applying) a coating layer on the functional layer. The coating layer includes carbon and a first metal. The forming of the functional layer includes performing a sputtering process to form (e.g., deposit) a second metal on the first surface of the negative electrode current collector. Each of the first metal and the second metal includes at least one lithiophilic element selected from among silver (Ag), gold (Au), magnesium (Mg), indium (In), titanium (Ti), gallium (Ga), platinum (Pt), palladium (Pd), silicon (Si), aluminum (Al), bismuth (Bi), tin (Sn), and/or zinc (Zn). The method is a method for manufacturing an all-solid-state battery.

### BRIEF DESCRIPTION OF DRAWINGS

FIG. 1 illustrates a plan view showing an all-solid-state battery according to one or more embodiments of the present disclosure.

FIG. 2 illustrates a cross-sectional view showing an all-solid-state battery according to one or more embodiments of the present disclosure.

FIG. 3 illustrates a cross-sectional view showing an all-solid-state battery according to one or more embodiments of the present disclosure.

FIG. 4 illustrates a cross-sectional view showing a negative electrode for an all-solid-state battery according to one or more embodiments of the present disclosure.

FIG. 5 illustrates an enlarged view showing section M of FIG. 4.

FIG. 6 illustrates an enlarged view showing section N of FIG. 4.

FIG. 7 illustrates a cross-sectional view showing a negative electrode for an all-solid-state battery according to one or more embodiments of the present disclosure.

FIG. 8 illustrates a SEM image that captures a negative electrode for an all-solid-state battery according to one or more embodiments of the present disclosure.

FIG. 9 illustrates a SEM image that captures a functional layer of a negative electrode according to one or more embodiments of the present disclosure.

FIG. 10 illustrates a graph showing cycle characteristics of all-solid-state batteries according to an example and a comparative example.

FIG. 11A illustrates a SEM image that captures a negative electrode for an all-solid-state battery according to Embodiment 1.

FIG. 11B illustrates a SEM image that captures a negative electrode for an all-solid-state battery according to other examples.

FIG. 12 illustrates an XRD analysis result of a negative electrode for an all-solid-state battery according to Embodiment 1.

### DETAILED DESCRIPTION

Hereinafter, embodiments of the present disclosure will be described clearly and in more detail to such an extent that those skilled in the art easily implement the present disclosure. In order to sufficiently understand the configuration and effect of the present disclosure, one or more embodiments of the present disclosure will be described with reference to the accompanying drawings. It should be noted, however, that the present disclosure is not limited to the following example embodiments, and may be implemented in one or more suitable forms. Rather, the example embodiments are provided only to disclose the present disclosure and let those skilled in the art fully know the scope of the present disclosure.

In this description, it will be understood that, if (e.g., when) an element is referred to as being on another element, the element can be directly on the other element or intervening elements may be present between therebetween. In contrast, if (e.g., when) an element is referred to as being “directly on” another element, there are no intervening elements present. In the drawings, thicknesses of some components are exaggerated for effectively explaining the technical contents. Like reference numerals refer to like elements throughout, and duplicative descriptions thereof may not be provided the specification.

Some embodiments detailed in this description will be discussed with reference to sectional and/or plan views as ideal example views of the present disclosure. In the drawings, thicknesses of layers and regions are exaggerated for effectively explaining the technical contents. Accordingly, regions exemplarily illustrated in the drawings have general properties, and shapes of regions exemplarily illustrated in the drawings are utilized to exemplarily disclose specific shapes but not limited to the scope of the present disclosure. It will be understood that, although the terms “first”, “second”, “third”, and/or the like. may be utilized herein to describe one or more suitable elements, these elements should not be limited by these terms. These terms are only utilized to distinguish one element from another element. The one or more embodiments explained and illustrated herein include complementary embodiments thereof.

Unless otherwise specially noted in this description, the expression of singular form (e.g., “a,” “an,” and/or “the”) may include the expression of plural form, including “at least one,” unless the context clearly dictates otherwise. In addition, unless otherwise specially noted, the phrase “A or B” may indicate “A but not B”, “B but not A”, and “A and B”. The terms “have/comprise/include”, “has/comprises/includes”, and/or “having/comprising/including” utilized in this description, are intended to designate the presence of an embodied aspect, number, step (e.g., act or task), element, and/or a (e.g., any suitable) combination thereof, and do not preclude or exclude the presence or addition of one or more other features, numbers, steps (e.g., acts or tasks), elements, components, and/or a (e.g., any suitable) combination thereof. Additionally, the terms “comprise(s)/comprising,” “include(s)/including,” “have/has/having”, or other similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

In one or more embodiments, the term “layer” herein includes not only a shape formed on the whole surface if (e.g., when) viewed from a plan view, but also a shape formed on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

The terminology utilized herein is utilized for the purpose of describing particular embodiments only, and is not intended to limit the present disclosure. Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In this context, “consisting essentially of” indicates that any additional components will not materially affect the chemical, physical, optical or electrical properties of the semiconductor film.

Further, in this specification, the phrase “on a plane,” or “plan view,” indicates viewing a target portion from the top, and the phrase “on a cross-section” indicates viewing a cross-section formed by vertically cutting a target portion from the side.

In this specification, the term “combination thereof” may refer to a mixture, a stack, a composite, a copolymer, an alloy, a blend, and/or a reaction product.

In this specification, the phrases such as “A or B”, “at least one among A and B”, “at least one of A or B”, “A, B, or C”, “at least one among A, B, and C”, and “at least one of A, B, or C” may each include any one of the items listed together in the corresponding phrase, among the phrases, or any possible combination thereof.

The term “particle diameter”, “particle size”, and/or the like as utilized herein refers to an average diameter of particles if (e.g., when) the particles are spherical, and refers to an average major axis length of particles if (e.g., when) the particles are non-spherical. For example, a particle diameter may be an average particle diameter. In some embodiments, a particle diameter indicates an average particle diameter (D₅₀) where a cumulative volume is about 50 volume % in a particle size distribution. The average particle diameter (D₅₀) may be measured by a method widely suitable to those skilled in the art, for example, by a particle size analyzer, a transmission electron microscope (TEM) image, or a scanning electron microscope (SEM) image. In one or more embodiments, a dynamic light-scattering measurement device is utilized to perform a data analysis, the number of particles is counted for each particle size range, and then from this, an average particle diameter (D₅₀) value may be obtained through a calculation. In one or more embodiments, a laser scattering method may be utilized to measure the average particle diameter (D₅₀). In the laser scattering method, a target particle is dispersed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

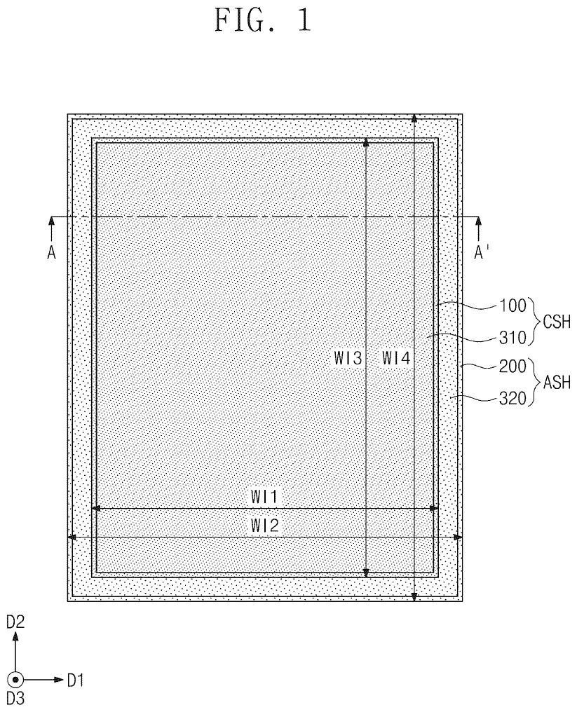

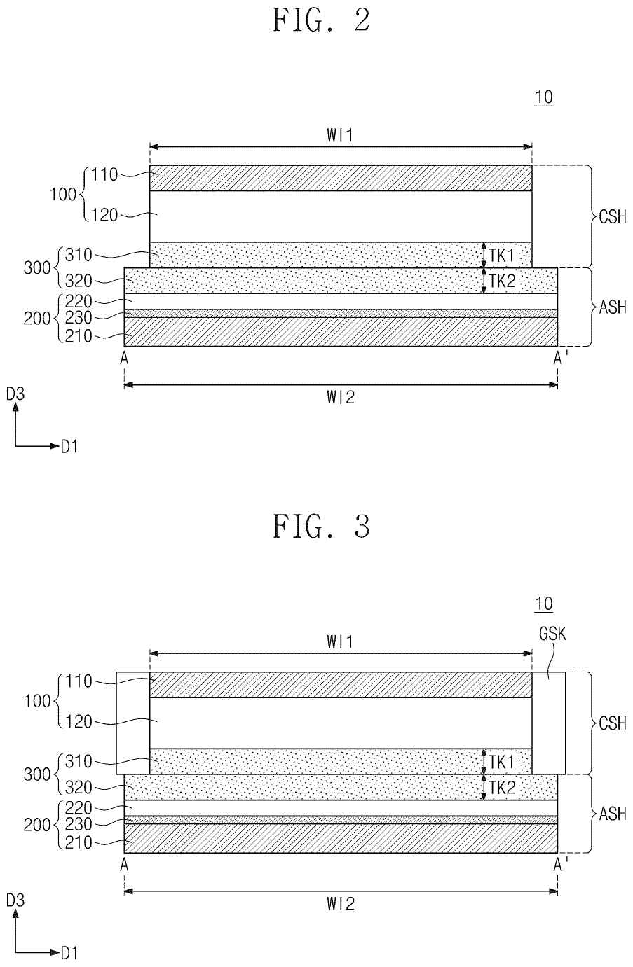

FIG. 1 illustrates a plan view showing an all-solid-state battery according to one or more embodiments of the present disclosure. FIG. 2 illustrates a cross-sectional view taken along the line A-A′ of FIG. 1.

Referring to FIGS. 1 and 2, an all-solid-state battery 10 according to the present disclosure may include a positive electrode layer 100, a negative electrode layer 200 opposite to the positive electrode layer 100, and a solid electrolyte layer 300 arranged between the positive electrode layer 100 and the negative electrode layer 200. The present disclosure, however, is not limited thereto, and the all-solid-state battery 10 may further include an additional functional layer, such as an adhesion enhancement layer, arranged between the positive electrode layer 100 and the solid electrolyte layer 300 and/or between the negative electrode layer 200 and the solid electrolyte layer 300.

The positive electrode layer 100 according to one or more embodiments of the present disclosure may include a positive electrode current collector 110 and a positive electrode active material layer 120 arranged on the positive electrode current collector 110. The positive electrode active material layer 120 may include a positive electrode active material, a solid electrolyte, a conductive material, and/or a binder.

The positive electrode current collector 110 may provide a reference surface on which the positive electrode active material layer 120 is arranged. The positive electrode current collector 110 may include a plate or foil including, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and/or an alloy thereof.

Differently from that shown in FIG. 2, in one or more embodiments of the present disclosure, the positive electrode current collector 110 may not be provided. In one or more embodiments, to increase the adhesion between the positive electrode current collector 110 and the positive electrode active material layer 120, a carbon layer having a thickness of (e.g., in a range of) about 0.1 μm to about 4 μm may further be arranged between the positive electrode current collector 110 and the positive electrode active material layer 120.

The positive electrode active material of the positive electrode active material layer 120 may include a material that may reversibly absorb and desorb lithium ions. The positive electrode active material may include a plurality of particles. For example, the positive electrode active material may include lithium transition metal oxide (e.g., lithium cobalt oxide (LCO), lithium nickel oxide, lithium nickel cobalt oxide, lithium nickel cobalt aluminum oxide (NCA), lithium nickel cobalt manganese oxide (NCM), lithium manganate, and/or lithium iron phosphate), nickel sulfide, copper sulfide, lithium sulfide, iron oxide, and/or vanadium oxide, but the present disclosure is not limited thereto. The positive electrode active material may be utilized alone or in a mixture of two or more substances.

The lithium transition metal oxide may be, for example, one or more compounds represented by one or more of (e.g., selected from among) LiₐA_{1-b}B_{b}D₂ (where 0.90≤a≤1 and 0≤b≤0.5), LiₐE_{1-b}B_{b}O_{2-c}D_{c} (where 0.90≤a≤1, 0≤b≤0.5, and 0≤c≤0.05), LiE_{2-b}B_{b}O_{4-c}D_{c} (where 0≤b≤0.5 and 0≤c≤0.05), LiₐNi_{1-b-c}Co_{b}B_{c}D_{α} (where 0.90≤a≤1, 0≤b≤0.5, 0≤c≤0.05, and 0<α<2), LiₐNi_{1-b-c}Co_{b}B_{c}O_{2-α}F_{α} (where 0.90≤a≤1, 0≤b≤0.5, 0≤c≤0.05, and 0<α<2), LiₐNi_{1-b-c}Mn_{b}B_{c}D_{α} (where 0.90≤a≤1, 0≤b≤0.5, 0≤c≤0.05, and 0<α≤2), LiₐNi_{1-b-c}Mn_{b}B_{c}O_{2-α}F_{α} (where 0.90≤a≤1, 0≤b≤0.5, 0≤c≤0.05, and 0<α<2), LiₐNi_{b}E_{c}G_{d}O₂ (where 0.90≤a≤1, 0≤b≤0.9, 0≤c≤0.5, and 0.001≤d≤0.1), LiₐNi_{b}Co_{c}Mn_{d}GₑO₂ (where 0.90≤a≤1, 0≤b≤0.9, 0≤c≤0.5, 0≤d≤0.5, and 0.001≤e≤0.1), LiₐNiG_{b}O₂ (where 0.9≤a≤1 and 0.001≤b≤0.1), LiₐCoG_{b}O₂ (where 0.90≤a≤1 and 0.001≤b≤0.1), LiₐMnG_{b}O₂ (where 0.90≤a≤1 and 0.001≤b≤0.1), LiₐMn₂G_{b}O₄ (where 0.90≤a≤1 and 0.001≤b≤0.1), QO₂, QS₂, LiQS₂, V₂O₅, LiV₂O₅, LiIO₂, LiNiVO₄, Li_{3-f}J₂(PO₄)₃ (where 0≤f≤2), Li_{3-f}Fe₂(PO₄)₃ (where 0≤f≤2), and/or LiFePO₄. In the compounds above, “A” may be Ni, Co, Mn, and/or (e.g., any suitable) combinations thereof, “B” may be Al, Ni, Co, Mn, Cr, Fe, Mg, Sr, V, a rare-earth element, and/or a (e.g., any suitable) combination thereof, “D” may be O, F, S, P, and/or a (e.g., any suitable) combination thereof, “E” may be Co, Mn, and/or a (e.g., any suitable) combination thereof, “F” may be F, S, P, and/or a (e.g., any suitable) combination thereof, “G” may be Al, Cr, Mn, Fe, Mg, La, Ce, Sr, V, and/or a (e.g., any suitable) combination thereof, “Q” may be Ti, Mo, Mn, and/or a (e.g., any suitable) combination thereof, “I” may be Cr, V, Fe, Sc, Y, and/or a (e.g., any suitable) combination thereof, and “J” may be V, Cr, Mn, Co, Ni, Cu, and/or a (e.g., any suitable) combination thereof.

The positive electrode active material may include, for example, lithium salt of transition metal oxide having a layered rock salt type (kind) structure among lithium transition metal oxides discussed above. The term “layered rock salt type (kind) structure” may refer to a structure in which an oxygen atom layer and a metal atom layer are alternately and regularly arranged in a <111> direction of a cubic rock salt type (kind) structure, where each atom layer forms a two-dimensional plane. The term “cubic rock salt type (kind) structure” may refer to a sodium chloride (NaCl) type (kind) structure, which is a type (kind) of crystal structure, and for example, has a structure in which face centered cubic lattices (FCCs) each formed of cations and anions are arranged displaced from (e.g., separated or apart (e.g., spaced and/or apart) from) each other by ½ of a ridge of a unit lattice. The lithium transition metal oxide having the layered rock salt type (kind) structure may be a ternary lithium transition metal oxide, such as LiNiₓCo_{y}Al_{z}O₂ (NCA) and/or LiNiₓCo_{y}Mn_{z}O₂ (NCM) (where 0<x<1, 0<y<1, 0<z<1, and x+y+z=1). If (e.g., when) the positive electrode active material includes a ternary lithium transition metal oxide having the layered rock salt type (kind) structure, the all-solid-state battery 10 may have increased energy density and improved thermal stability.

The compound included in the positive electrode active material may be covered with a coating layer. The positive electrode active material may be utilized in a mixture of the compound and a compound to which the coating layer is added. The coating layer added to a surface of the positive electrode active material may include, for example, oxide, hydroxide, oxyhydroxide, oxycarbonate, and/or hydrocarbonate of a coating element discussed. The compound that constitutes the coating layer may be amorphous and/or crystalline. The coating element included in the coating layer may include Mg, Al, Co, K, Na, Ca, Si, Ti, V, Sn, Ge, Ga, B, As, Zr, and/or a (e.g., any suitable) mixture thereof. The coating layer may include, for example, Li₂O—ZrO₂ (LZO). A method for forming the coating layer may be selected within any methods that do not adversely affect physical characteristics of the positive electrode active material. The method of forming the coating layer may include, for example, spray coating and/or immersion.

If (e.g., when) the positive electrode active material includes nickel (Ni) as a ternary lithium transition metal oxide such as NCA and/or NCM, a capacity density of the all-solid-state battery 10 may increase to reduce metal elution from the positive electrode active material in a charged state. Therefore, the all-solid-state battery 10 may improve cycle characteristics in a charged state. The term “cycle characteristics” may refer to properties that indicate the degree to which the all-solid-state battery 10 is degraded due to charge and discharge. For example, the all-solid-state battery 10 with high cycle characteristics may degrade less due to charge and discharge, while the all-solid-state battery 10 with low cycle characteristics may degrade more due to charge and discharge.

The positive electrode active material may have, for example, a spherical or oval particulate shape. There is no limitation on a particle diameter and an amount of the positive electrode active material.

The solid electrolyte of the positive electrode active material layer 120 may have a particulate shape. The solid electrolyte may be dispersed between the positive electrode active materials. The solid electrolyte may include a sulfide-based solid electrolyte with excellent or suitable lithium ionic conductivity. The sulfide-based solid electrolyte may include, for example, at least one selected from among Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive integer, and “Z” is one of Ge, Zn, and Ga), Li₂S—GeS₂, Li₂S—SiS₂—Li₃PO₄, Li₂S—SiS₂-LiₚMO_{q} (where p and q are each a positive integer, and “M” is one of P, Si, Ge, B, Al, Ga, and In), Li₇₋ₓPS₆₋ₓClₓ (where 0≤x≤2), Li₇₋ₓPS₆₋ₓBrₓ (where 0≤x≤2), and/or Li₇₋ₓPS₆₋ₓIₓ (where 0≤x≤2).

The sulfide-based solid electrolyte may be an argyrodite-type (kind) compound including, for example, at least one selected from among Li₇₋ₓPS₆₋ₓClₓ (where 0≤x≤2), Li₇₋ₓPS₆₋ₓBrₓ (where 0≤x≤2), and/or Li₇₋ₓPS₆₋ₓIₓ (where 0≤x≤2). For example, the sulfide-based solid electrolyte may be an argyrodite-type (kind) compound including at least one selected from among Li₆PS₅Cl, Li₆PS₅Br, and/or Li₆PS₅I.

In one or more embodiments, the sulfide-based solid electrolyte may be an argyrodite-type (kind) compound including Li₇₋ₐMₐPS_{6-c}X_{c} (where 0≤a≤2 and 0≤c≤2). In the chemical formula above, X may be F, Br, CI, and/or a (e.g., any suitable) combination thereof. M may be scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (Al), gallium (Ga), indium (In), thallium (TI), silicon (Si), germanium (Ge), tin (Sₙ), lead (Pb), arsenic (As), antimony (Sb), bismuth (Bi), and/or a (e.g., any suitable) combination thereof.

The argyrodite-type (kind) solid electrolyte may have a density of about 1.5 g/cc to about 2.0 g/cc. As the argyrodite-type (kind) solid electrolyte has a density of equal to or greater than about 1.5 g/cc, it may be possible to decrease an internal resistance of an all-solid-state battery and to prevent or reduce a solid electrolyte layer from a short circuit and penetration caused by the formation of lithium dendrites. The solid electrolyte may have an elastic modulus of, for example, about 15 GPa to about 35 GPa.

The solid electrolyte in the positive electrode active material layer 120 may be in a form of particles and have an average particle diameter less than those of first and second electrolytes in the solid electrolyte layer 300 which will be discussed. For example, the average particle diameter of the solid electrolyte (in a form of particles) in the positive electrode active material layer 120 may be about equal to or less than about 90%, about 80%, about 70%, about 60%, about 50%, about 40%, about 30%, or about 20% of the average particle diameter of a solid electrolyte included in the solid electrolyte layer 300. The average particle diameter may be a median diameter measured with a laser-type (kind) particle size distribution analyzer.

The positive electrode active material layer 120 may include a conductive material. The conductive material may have conductivity without causing a chemical change of the all-solid-state battery 10 to increase conductivity of the positive electrode active material and the solid electrolyte. The conductive material may include a carbon-based material. The conductive material may include, for example, one or more of graphite, carbon black, acetylene black, carbon nano-fiber, and/or carbon nano-tube.

The positive electrode active material layer 120 may further include a binder. The binder may combine the positive electrode active material, the solid electrolyte, and/or the conductive material in the positive electrode active material layer 120. The binder may include a material that improves adhesion between the positive electrode active material layer 120 and the positive electrode current collector 110. The binder may include, for example, polyvinylidenefluoride, styrene-butadiene rubber (SBR), polytetrafluoroethylene, vinylidenefluoride/hexafluoropropylene copolymer, polyacrylonitrile, and/or polymethyl methacrylate.

Based on the total 100 parts by weight of the positive electrode active material, the solid electrolyte, the conductive material, and the binder (e.g., the total 100 parts by weight of the positive electrode active material layer 120), the positive electrode active material may be included in an amount of about 85 parts by weight to about 92 parts by weight in the positive electrode active material layer 120. Based on the total 100 parts by weight of the positive electrode active material (e.g., the total 100 parts by weight of the positive electrode active material layer 120), the solid electrolyte, the conductive material, and the binder, the positive binder may be included in an amount of about 0.5 parts by weight to about 1.5 parts by weight in the positive electrode active material layer 120. For example, the positive electrode active material layer 120 is composed of the positive electrode active material, solid electrolyte, conductive material, and binder. The positive electrode active material constitutes about 85 to 92 parts by weight, while the binder constitutes about 0.5 to 1.5 parts by weight, based on a total of 100 parts by weight of the positive electrode active material layer 120.

Based on 100 parts by weight of the solid electrolyte, the conductive material may be included in an amount of about 1 part by weight to about 50 parts by weight in the positive electrode active material layer 120 (e.g., the weight ratio of the solid electrolyte to the conductive material in the positive electrode active material layer 120 is about 100:1 to about 2:1). If (e.g., when) the conductive material is included in an amount of less than about 1 part by weight relative to 100 parts by weight of the solid electrolyte, a proportion of the conductive material may decrease to reduce an electrical conductivity of the positive electrode active material layer 120. If (e.g., when) the conductive material is included in an amount of greater than about 50 parts by weight relative to 100 parts by weight of the solid electrolyte, a proportion of the conductive material may excessively (or substantially) increase to cause incomplete formation of a coating layer that covers a surface of the solid electrolyte. For example, the positive electrode active material layer 120 includes the conductive material (e.g., the electron conductor) in an amount ranging from about 1 to 50 parts by weight per 100 parts by weight of the solid electrolyte. If the conductive material is less than 1 part by weight, the electrical conductivity may decrease. If (e.g., when) it exceeds 50 parts by weight, the formation of a coating layer on the solid electrolyte surface may be incomplete.

The positive electrode active material layer 120 may further include an additive, such as a filler, a coating agent, a dispersant, and/or an ionic conductivity agent, in addition to the positive electrode active material, the solid electrolyte, the conductive material, and the binder.

The negative electrode layer 200 may include a negative electrode current collector 210, a functional layer 230 on the negative electrode current collector 210, and a coating layer 220 on the functional layer 230.

The negative electrode current collector 210 may provide a reference surface on which the coating layer 220 is arranged. The negative electrode current collector 210 may include a material that does not react with lithium, for example, a material that does not form an alloy and/or a compound with lithium. For example, the negative electrode current collector 210 may include at least one metal selected from among copper (Cu), stainless steel, titanium (Ti), iron (Fe), cobalt (Co), and/or nickel (Ni). A thickness of the negative electrode current collector 210 may be in a range of about 1 μm to about 20 μm, for example, about 5 μm to about 15 μm, or about 7 μm to about 10 μm.

The negative electrode current collector 210 may be formed of (e.g., include) one of the metals mentioned above (e.g., Cu, Ti, Fe, Co, and/or Ni), an alloy of two or more of the metals mentioned above (e.g., Cu, Ti, Fe, Co, and/or Ni), or a coating material. The negative electrode current collector 210 may have, for example, a plate or foil shape. In one or more embodiments, the negative electrode current collector 210 may not be provided.

In one or more embodiments, a carbon layer may further be included to increase adhesion between the coating layer 220 and the solid electrolyte layer 300.

The solid electrolyte layer 300 may be provided between the positive electrode layer 100 and the negative electrode layer 200. The solid electrolyte layer 300 may include a sulfide-based solid electrolyte with excellent or suitable lithium ionic conductivity. The solid electrolyte included in the solid electrolyte layer 300 may include a material the same as or different from that of the solid electrolyte included in the positive electrode active material layer 120.

The solid electrolyte layer 300 may include a first solid electrolyte layer 310 and a second solid electrolyte layer 320. The first solid electrolyte layer 310 may be adjacent to the positive electrode layer 100, and the second solid electrolyte layer 320 may be adjacent to the negative electrode layer 200.

Referring to FIG. 2, the first solid electrolyte layer 310 may include a first solid electrolyte. The first solid electrolyte may have a spherical or oval particulate shape. The first solid electrolyte may include a sulfide-based solid electrolyte. The first solid electrolyte may be in an amorphous state, a crystalline state, or a mixed state of amorphous and crystalline states. The solid electrolyte may include at least sulfur(S), phosphorus (P), and/or lithium (Li) among component elements included in the sulfide-based solid electrolyte mentioned above. For example, the solid electrolyte may be a material including Li₂S—P₂S₅. If (e.g., when) Li₂S—P₂S₅ is utilized as the sulfide-based solid electrolyte material of the solid electrolyte, a mixing molar ratio of Li₂S and P₂S₅ may be in a range of about 50:50 to about 90:10.

For example, the first solid electrolyte may include an argyrodite-type (kind) compound including, for example, at least one selected from among Li₇₋ₓPS₆₋ₓClₓ (where 0≤x≤2), Li₇₋ₓPS₆₋ₓBrₓ (where 0≤x≤2), and/or Li₇₋ₓPS₆₋ₓIₓ (where 0≤x≤2). The first solid electrolyte may include an argyrodite-type (kind) compound including at least one selected from among Li₆PS₅Cl, Li₆PS₅Br, and/or Li₆PS₅I.

In one or more embodiments, the first solid electrolyte may include an argyrodite-type (kind) compound including Li₇₋ₐMₐPS_{6-c}X_{c}. In the chemical formula above, X may be CI, Br, and/or a (e.g., any suitable) combination thereof. M may be Na, K, Fe, Mg, Ca, Ag, Cu, Zr, Zn, and/or a (e.g., any suitable) combination thereof. The subscripts a and c may each be a real number between 0 and 2.

The argyrodite-type (kind) solid electrolyte may have a density in a range of about 1.5 g/cc to about 2.0 g/cc. As the argyrodite-type (kind) solid electrolyte has a density of equal to or greater than about 1.5 g/cc, it may be possible to decrease an internal resistance of an all-solid-state battery and to prevent or reduce a solid electrolyte layer from a short circuit and penetration caused by the formation of lithium dendrites. The first solid electrolyte may have a modulus of, for example, about 15 GPa to about 35 GPa.

The first solid electrolyte layer 310 may further include a binder. The binder included in the first solid electrolyte layer 310 may include, for example, styrene-butadiene rubber (SBR), polytetrafluoroethylene, polyvinylidenefluoride, and/or polyethylene, but the present disclosure is not limited thereto. The binder of the first solid electrolyte layer 310 may be the same as or different from that of the positive electrode active material layer 120 and/or that of the coating layer 220.

The second solid electrolyte layer 320 may include a second solid electrolyte. The second solid electrolyte may have a spherical or oval particulate shape.

The second solid electrolyte may include a sulfide-based solid electrolyte. A description of the second solid electrolyte may be the same as or similar to that of the first solid electrolyte. In one or more embodiments, the second solid electrolyte may have substantially the same composition as that of the first solid electrolyte. In one or more embodiments, the second solid electrolyte may have a similar composition to that of the first solid electrolyte.

The second solid electrolyte may be in direct contact with the coating layer 220. Thus, the second solid electrolyte may suppress or reduce lithium dendrites formed between the coating layer 220 and the negative electrode current collector 210. The second solid electrolyte may effectively suppress or reduce negative electrode side reactions. Therefore, the all-solid-state battery 10 according to the present disclosure may improve cell performance.

The first solid electrolyte layer 310 may have a first thickness TK1, and the second solid electrolyte layer 320 may have a second thickness TK2. The first thickness TK1 and the second thickness TK2 may be the same as or different from each other. In one or more embodiments, the first thickness TK1 may be greater than the second thickness TK2. For example, the first thickness TK1 may be about 1.1 to 5 times the second thickness TK2.

Referring to FIGS. 1 and 2, the positive electrode layer 100 and the first solid electrolyte layer 310 may constitute a positive electrode mixture layer CSH. The negative electrode layer 200 and the second solid electrolyte layer 320 may constitute a negative electrode mixture layer ASH. The positive electrode mixture layer CSH may be stacked on the negative electrode mixture layer ASH.

The negative electrode mixture layer ASH and the positive electrode mixture layer CSH may have their areas different from each other. For example, the area of the negative electrode mixture layer ASH may be greater than that of the positive electrode mixture layer CSH. The positive electrode mixture layer CSH may completely or substantially overlap the negative electrode mixture layer ASH inwardly.

In one or more embodiments of the present disclosure, the first solid electrolyte layer 310 may have substantially the same area as that of the positive electrode layer 100. The second solid electrolyte layer 320 may have substantially the same area as that of the negative electrode layer 200.

For example, the positive electrode mixture layer CSH may have a first width WI1 in a first direction D1. The negative electrode mixture layer ASH may have a second width WI2 in the first direction D1. The first width WI1 may be less than the second width WI2. The positive electrode mixture layer CSH may have a third width WI3 in a second direction D2. The negative electrode mixture layer ASH may have a fourth width WI4 in the second direction D2. The third width WI3 may be less than the fourth width WI4.

The all-solid-state battery 10 according to the present embodiment may be fabricated/manufactured by forming the negative electrode mixture layer ASH on a first carrier film, forming the positive electrode mixture layer CSH on a second carrier film, and then laminating the negative electrode mixture layer ASH and the positive electrode mixture layer CSH.

FIG. 3 illustrates a cross-sectional view taken along the line A-A′ of FIG. 1, showing an all-solid-state battery according to one or more embodiments of the present disclosure. A detailed description of technical features repetitive to those discussed above with reference to FIGS. 1 and 2 will not be provided, and a difference thereof will be discussed in more detail.

Referring to FIG. 3, the all-solid-state battery 10 may include a gasket GSK. The gasket GSK may be provided to be around (e.g., surround) the positive electrode mixture layer CSH. A difference in area between the negative electrode mixture layer ASH and the positive electrode mixture layer CSH may produce a step difference (e.g., a gap in the first direction D1) on a lateral surface of the all-solid-state battery 10, and the gasket GSK may fill the step difference. The gasket GSK may be around (e.g., surround) four lateral surfaces of the positive electrode mixture layer CSH. For example, a thickness of the gasket GSK may be substantially the same as that of the positive electrode mixture layer CSH.

A top surface of the second solid electrolyte layer 320 may include a first region in contact with the first solid electrolyte layer 310 and a second region in contact with the gasket GSK. The second region may be a peripheral area of the top surface of the second solid electrolyte layer 320. The second region may be around (e.g., surround) the first region.

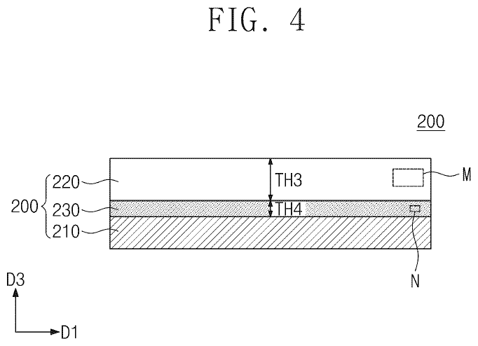

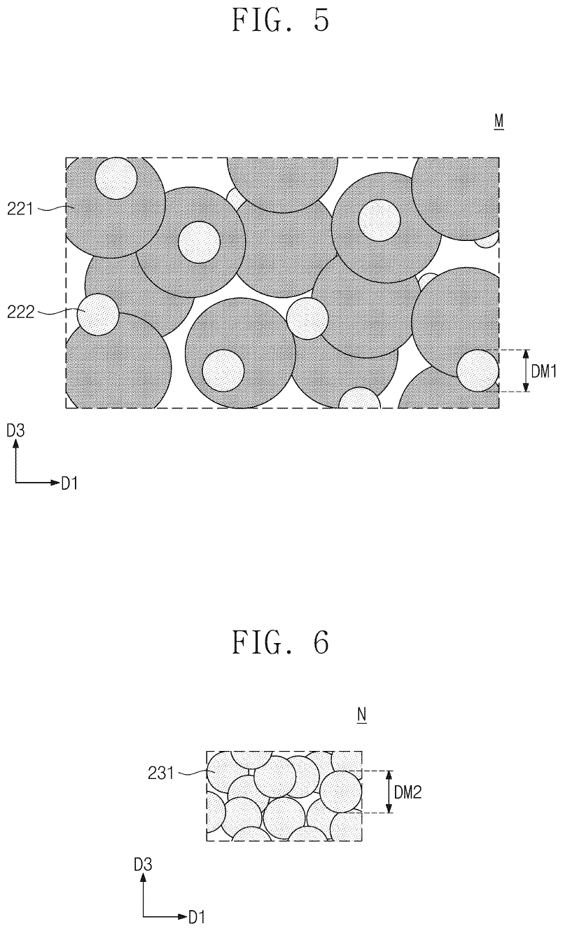

FIG. 4 illustrates a cross-sectional view showing a negative electrode for an all-solid-state battery according to one or more embodiments of the present disclosure. FIG. 5 illustrates an enlarged view showing section M of FIG. 4. FIG. 6 illustrates an enlarged view showing section N of FIG. 4. A negative electrode for an all-solid-state battery according to the present disclosure will be discussed in more detail with reference to FIGS. 4 to 6.

The coating layer 220 may include carbon 221 and a first metal 222. In the coating layer 220, an amount of the carbon 221 may be greater than that of the first metal 222. The carbon 221 may be present in an amount of about 50 parts by weight to about 99 parts by weight relative to 100 parts by weight of the coating layer 220. The first metal 222 may be present in an amount of about 1 part by weight to about 50 parts by weight relative to 100 parts by weight of the coating layer 220.

The coating layer 220 may include at least one carbon selected from among carbon black, acetylene black, furnace black, Ketjen black, and/or graphene. In one or more embodiments, the coating layer 220 may include a mixture of carbon black and silver (Ag).

The coating layer 220 may further include an additive in addition to the carbon 221 and the first metal 222. The coating layer 220 may include at least one additive selected from among, for example, a binder, a filler, a coating agent, a dispersant, and/or an ionic conductivity agent.

The binder included in the coating layer 220 may include at least one selected from among styrene-butadiene rubber (SBR), polytetrafluoroethylene, polyvinylidenefluoride (PVdF), polyethylene, vinylidenefluoride/hexafluoropropylene copolymer, polyacrylonitrile, and/or polymethylmethacrylate.

The binder may be included in an amount of about 1 part by weight to about 30 parts by weight relative to 100 parts by weight of the coating layer 220. For example, the binder may be included in an amount of about 5 parts by weight to about 15 parts by weight relative to 100 parts by weight of the coating layer 220.

The functional layer 230 may be between (e.g., interposed between) the negative electrode current collector 210 and the coating layer 220. The functional layer 230 may include a second metal 231. The functional layer 230 may include an alloy of the second metal 231 and lithium. This may be because that lithium adsorbed into the functional layer 230 and the second metal 231 are combined to constitute the alloy. An amount of the second metal 231 in the functional layer 230 may be greater than that of the first metal 222 in the coating layer 220. The amount of the second metal 231 in the functional layer 230 may be the same as that of the first metal 222 in the coating layer 220.

A thickness TH3 of the coating layer 220 may be greater than a thickness TH4 of the functional layer 230. The thickness TH3 of the coating layer 220 may be in a range of about 5 μm to about 10 μm. The thickness TH4 of the functional layer 230 may be in a range of about 30 nm to about 4 μm. For example, the thickness TH4 of the functional layer 230 may be in a range of about 50 nm to about 3.5 μm.

If (e.g., when) the thickness TH4 of the functional layer 230 is less than the range above (e.g., the range of about 30 nm to about 4 μm), an ionic conductivity of lithium may not be improved, and lithium metal may be irregularly formed on (e.g., deposited on) the negative electrode current collector 210 to result in formation of dendrites. If (e.g., when) the thickness TH4 of the functional layer 230 is greater than the range above (e.g., the range of about 30 nm to about 4 μm), an energy density of an all-solid-state battery may be decreased to cause a reduction in cycle characteristics of the all-solid-state battery. In contrast, if (e.g., when) the thickness TH4 of the functional layer 230 falls within the range above (e.g., the range of about 30 nm to about 4 μm), lithium metal may be uniformly (e.g., substantially uniformly) formed on (e.g., deposited on) a subsequently described deposition layer 240 during charge, and thus an all-solid-state battery may improve in lifespan characteristics. In addition, the functional layer 230 may induce excellent or suitable electrical conductivity to yield a superior rapid charge.

The first metal 222 of the coating layer 220 and the second metal 231 of the functional layer 230 may each include a lithiophilic element. The lithiophilic element may refer to a metal that exhibits high affinity with lithium. The lithiophilic element may not be lithium. The metal that has high affinity with lithium may indicate a metal on which lithium ions are readily adsorbed on a surface thereof and lithium is uniformly (e.g., substantially uniformly) electrodeposited.

The first and second metals 222 and 231 may have their high lithium diffusion coefficients. For example, each of the first and second metals 222 and 231 may have a lithium diffusion coefficient in a range of about 10⁻¹⁴ cm²/s to about 10⁻⁶ cm²/s. The present disclosure, however, is not limited thereto. Each of the first and second metals 222 and 231 may have a high bonding energy with lithium. For example, each of the first and second metals 222 and 231 may have a lithium bonding energy of about 0.2 eV to about 0.5 eV. The present disclosure, however, is not limited thereto.

For example, the first metal 222 and the second metal 231 may each include at least one metal selected from among gold (Au), platinum (Pt), palladium (Pd), silicon (Si), silver (Ag), aluminum (Al), bismuth (Bi), tin (Sn), and/or zinc (Zn). The first metal 222 and the second metal 231 may be the same metal, but the present disclosure is not limited thereto. In one or more embodiments, the first metal 222 and the second metal 231 may be different metals.

As each of the coating layer 220 and the functional layer 230 includes a metal that exhibits high affinity with lithium, lithium ions may be readily adsorbed on the coating layer 220 and the functional layer 230. According to the present disclosure, as the functional layer 230 is further included between the negative electrode current collector 210 and the coating layer 220, lithium may be uniformly (e.g., substantially uniformly) deposited on a deposition layer 240 between the negative electrode current collector 210 and the functional layer 230.

A particle size of the first metal 222 may be greater than that of the second metal 231. For example, the first metal and the second metal are each in a form of particles, and an average particle diameter DM1 of (the particles of) the first metal 222 may be less than an average particle diameter DM2 of (the particles of) the second metal 231. As the second metal 231 is formed on (e.g., deposited on) the negative electrode current collector 210 in a sputtering process of manufacturing/fabrication procedure which will be discussed, the first metal 222 may have a relatively small particle size. The average particle diameter DM1 of the first metal 222 may be in a range of about 30 nm to about 80 nm. The average particle diameter DM2 of the second metal 231 may be in a range of about 1 nm to about 20 nm.

As the first metal 222 has a larger particle diameter than that of the second metal 231, a surface roughness of the functional layer 230 may be less than that of the coating layer 220. For example, the coating layer 220 may have a surface roughness in a range of about 0.5 μm to about 1 μm. The functional layer 230 may have a surface roughness in a range of about 0.1 μm to about 0.4 μm.

A porosity of the coating layer 220 may be greater than that of the functional layer 230. The porosity of the coating layer 220 may refer to a ratio of an empty space in the coating layer 220 to a volume of the coating layer 220. The porosity of the functional layer 230 may refer to a ratio of an empty space in the functional layer 230 to a volume of the functional layer 230.

According to the present disclosure, the functional layer 230 may be between (e.g., interposed between) the negative electrode current collector 210 and the coating layer 220. The functional layer 230 may include a metal including a lithiophilic element. As the functional layer 230 has a high affinity with lithium, it may be possible to improve lithium ionic conductivity that decreases in a direction from the coating layer 220 toward the negative electrode current collector 210. In conclusion, an all-solid-state battery may improve electrical properties and lifespan characteristics.

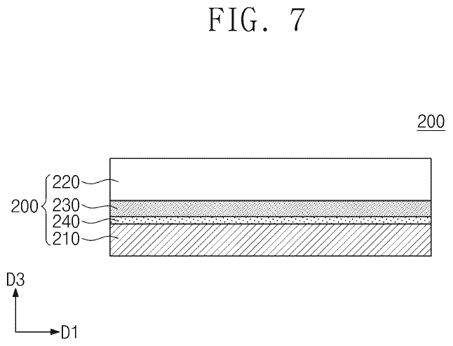

FIG. 7 illustrates a cross-sectional view showing a negative electrode for an all-solid-state battery according to one or more embodiments of the present disclosure. In one or more embodiments that follows, a detailed description of technical features repetitive to those discussed above with reference to FIGS. 4 to 6 will not be provided, and a difference thereof will be discussed in more detail.

Referring to FIG. 7, a deposition layer 240 may be included between the negative electrode current collector 210 and the functional layer 230. The deposition layer 240 may include deposited lithium. The deposition layer 240 may induce growth of lithium metal within the deposition layer 240 if (e.g., when) the all-solid-state battery 10 is charged. The deposition layer 240 may serve as a protection layer for lithium metal and concurrently (e.g., simultaneously) may suppress or reduce precipitation and growth of lithium dendrites.

According to the present disclosure, the functional layer 230 and the negative electrode current collector 210 may be provided therebetween with the deposition layer 240 wherein lithium is formed (e.g., deposited). The presence of the deposition layer 240 may suppress or reduce precipitation and growth of dendrites. In conclusion, an all-solid-state battery may improve electrical properties and lifespan characteristics.

The following will describe a method for manufacturing an all-solid-state battery according to the present disclosure. Repetitions of technical features discussed above in FIGS. 2 to 6 may not be provided.

Referring to FIGS. 1 and 2, a method for manufacturing an all-solid-state battery may include forming a negative electrode mixture layer ASH, forming a positive electrode mixture layer CSH, and laminating the negative electrode mixture layer ASH and the positive electrode mixture layer CSH. The formation of the negative electrode mixture layer ASH may include forming a functional layer 230 on a first surface of a negative electrode current collector 210 and forming a coating layer 220 on the functional layer 230. The functional layer 230 and the coating layer 220 may be sequentially stacked on the negative electrode current collector 210.

The formation of the functional layer 230 may include performing a physical deposition method. For example, a sputtering process may be employed to form the functional layer 230. For example, an inside of a chamber may be maintained at vacuum or low pressures, and an inert gas may be introduced to generate plasma. Ions in the generated plasma may collide at a high speed with a metal thin layer to emit metal particles. The emitted particles may be deposited on the negative electrode current collector 210 to form a thin layer. Thus, the functional layer 230 may be formed which includes metal particles. The metal thin layer may include at least one lithiophilic element selected from among silver (Ag), gold (Au), magnesium (Mg), indium (In), titanium (Ti), gallium (Ga), platinum (Pt), palladium (Pd), silicon (Si), aluminum (Al), bismuth (Bi), tin (Sn), and/or zinc (Zn).

As the sputtering process is utilized, the functional layer 230 may be uniformly (e.g., substantially uniformly) formed on the negative electrode current collector 210. In addition, a metal particle size of the functional layer 230 may be less than that of the coating layer 220. Thus, a surface roughness of the functional layer 230 may be less than that of the coating layer 220.

The following will describe an example and a comparative example of the present disclosure. The following embodiments, however, are merely example, and the present disclosure is not limited to one or more embodiments discussed.

### Embodiment 1

A Steel Use Stainless (SUS) foil of 10 μm in thickness was prepared as a negative electrode current collector. A sputtering process was performed to form (e.g., deposit) silver (Ag) on a top surface of the negative electrode current collector, thereby preparing a functional layer. For example, an ionized argon gas was introduced into a vacuum chamber to produce plasma. The argon particles in the plasma collided at a high speed with a silver (Ag) foil to form (e.g., deposit) silver (Ag) particles on the top surface of the negative electrode current collector. The silver (Ag) particles of the functional layer had an average particle diameter of 10 nm. A thickness of the functional layer was 50 nm.

There was prepared silver (Ag) with an average particle diameter of 40 nm to 70 nm. Carbon black (CAS #1333-86-4) as amorphous carbon and silver (Ag) were mixed in a weight ratio of 85:15 to prepare a coating layer slurry. Afterwards, the coating layer slurry was coated on the functional layer, and the mixture was dried to form a coating layer of 10 μm in thickness.

A negative electrode manufactured as described above (e.g., embodiments discussed in FIGS. 4 to 6), a solid electrolyte layer, and a positive electrode were stacked to manufacture an all-solid-state battery.

### Embodiment 2

A negative electrode and an all-solid-state battery were prepared in substantially the same method as in Embodiment 1, except that a thickness of the functional layer was 1 μm.

### Embodiment 3

A negative electrode and an all-solid-state battery were prepared in substantially the same method as in Embodiment 1, except that a thickness of the functional layer was 3.5 μm.

### Comparative 1

A coating layer was prepared by coating and drying a coating layer slurry on a SUS foil as a negative electrode current collector without forming a functional layer. Except that described above (e.g., preparing the negative electrode current collector without forming the functional layer), a negative electrode and an all-solid-state battery were prepared in substantially the same method as in Embodiment 1.

In summary, in Embodiment 1, a 10 μm thick stainless steel (SUS) foil was used as the negative electrode current collector, with a functional layer of silver (Ag) particles (10 nm average diameter) deposited via sputtering to a thickness of 50 nm. A coating layer slurry, prepared by mixing silver (Ag) particles (40-70 nm average diameter) and carbon black in an 85:15 weight ratio, was applied and dried to form a 10 μm thick coating layer. This negative electrode, along with a solid electrolyte layer and a positive electrode, was used to fabricate an all-solid-state battery. In contrast, Embodiments 2 and 3 varied the thickness of the functional layer to 1 μm and 3.5 μm, respectively, while Comparative 1 omitted the functional layer entirely, applying the coating layer slurry directly to the SUS foil.

Table 1 shows comparison between the negative electrodes according to Embodiments 1 to 3 and Comparative 1.

TABLE 1

| | Coating layer (100 parts | | |
|---|---|---|---|
| | by weight) | | Thickness of |
| | Carbon black | Silver (Ag) | functional layer |
| Embodiment 1 | 85 | 15 | 50 nm |
| Embodiment 2 | | | 1 μm (1,000 nm) |
| Embodiment 3 | | | 3.5 μm (3,500 nm) |
| Comparative 1 | | | 0 |

### Experimental Example 1: SEM Analysis

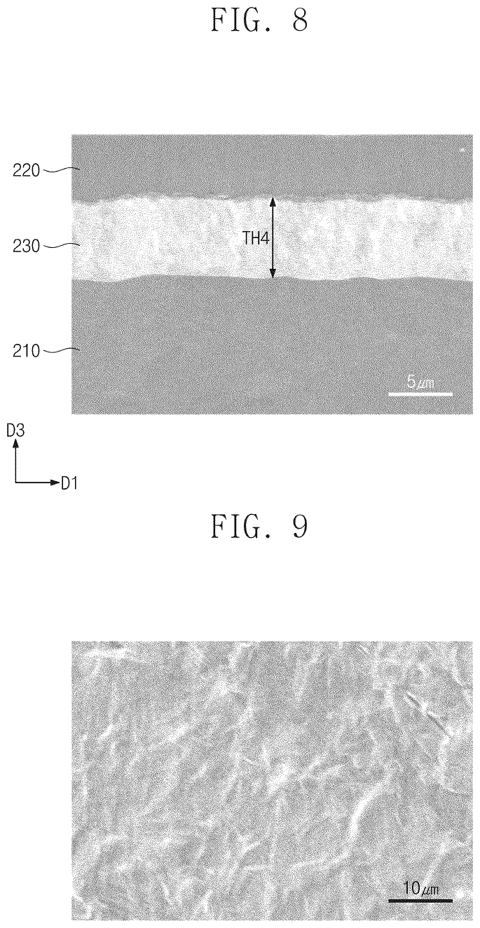

A scanning electron microscope (SEM) was utilized to analyze a cross-section of the negative electrode of the all-solid-state battery manufactured in Embodiment 1. FIG. 8 illustrates a SEM image that captures a negative electrode for an all-solid-state battery according to one or more embodiments of the present disclosure. FIG. 9 illustrates a SEM image that captures a functional layer of a negative electrode according to one or more embodiments of the present disclosure.

Referring to FIGS. 8 and 9, it may be observed that the functional layer 230 was satisfactorily formed between the negative electrode current collector 210 and the coating layer 220. It may be observed that the functional layer 230 was formed to have a thickness TH4 of about 2 μm.

### Experimental Example 2: Evaluation of Cycle Characteristics

Each of the all-solid-state batteries manufactured in Embodiment 1, Embodiment 3, and Comparative 1 was allowed to evaluate its cycle characteristics. For example, a capacity change rate with respect to the number of charge-discharge cycles (cycle number, #) was measured at 45° C. under the condition of a current density of 0.5 mAcm⁻², a capacity of 2 mAhcm⁻², and a cut-off voltage of 1 V during repeated charge and discharge. The total number of charge-discharge cycles was 130. The capacity change rate is defined as a ratio of a capacity after 130 cycles to an initial capacity.

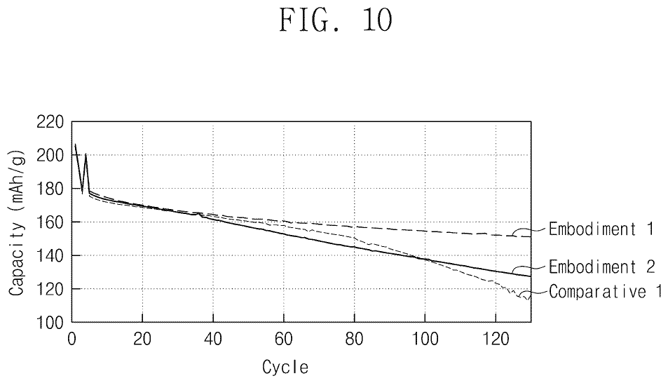

Referring to FIG. 10, the capacity change rate of Embodiment 1 was 55.38%, and the capacity change rate of Embodiment 3 was 77.99%. In contrast, the capacity change rate of Comparative 1 was 87.36%, showing a higher capacity change rate compared to the examples. It may be estimated that the all-solid-state battery including the functional layer exhibits a relatively smaller capacity change rate during repeated charge-discharge cycles. This may be because that the functional layer induces an increase in the degree of activity of lithium deposition and promotes substantially uniform lithium deposition to result in stable charge and discharge.

In conclusion, it may be ascertained that the all-solid-state batteries according to Embodiments 1 and 3 show a significant improvement in lifespan characteristics compared to the all-solid-state battery according to Comparative 1.

### Experimental Example 3: Measurement of Initial Capacity Efficiency

For each of the all-solid-state batteries manufactured in Embodiment 1, Embodiment 3, and Comparative 1, initial capacity efficiency (ICE) was measured as follows. At a temperature of 45° C., the all-solid-battery was charged at a constant current of 0.05 C to an upper limit voltage of 4.25 V, and then discharged at a constant current of 0.05 C to a cut-off voltage of 2.5 V. An initial charge capacity and an initial discharge capacity were measured, and the results are shown in Table 2. In Table 1, the initial capacity efficiency (%) is expressed by Mathematical Equation 1.

$$Initial capacity efficiency ( \% ) = ( initial discharge capacity / initial charge capacity ) \times 100 \qquad Mathematical Equation 1$$

TABLE 2

| | Initial | Initial | Initial | Capacity |
|---|---|---|---|---|
| | charge | discharge | capacity | retention rate |
| | capacity | capacity | efficiency | (lifespan) at |
| | [mAh/g] | [mAh/g] | [%] | 130 cycles |
| Embodiment 1 | 236.19 | 196.33 | 83.12 | 73 |
| Embodiment 3 | 235.87 | 195.21 | 83.76 | 62 |
| Comparative 1 | 235.50 | 195.51 | 83.02 | 57 |

Referring to Table 2, in Embodiment 1, the initial charge capacity is 236.19 mAh/g, the initial discharge capacity is 196.33 mAh/g, and the initial capacity efficiency is 83.12%. In Embodiment 3, the initial charge capacity is 235.87 mAh/g, the initial discharge capacity is 195.21 mAh/g, and the initial capacity efficiency is 83.76%. In contrast, in Comparative 1, the initial charge capacity is 235.50 mAh/g, the initial discharge capacity is 195.51 mAh/g, and the initial capacity efficiency is 83.02%. The initial capacity efficiency of Comparative 1 is less than that of Embodiment 1 and that of Embodiment 3. Thus, it may be found that the all-solid-state battery including the functional layer has improved initial charge efficiency.

In conclusion, it may be ascertained that the all-solid-state batteries according to Embodiments 1 and 3 show a significant improvement in lifespan characteristics compared to the all-solid-state battery according to Comparative 1.

### Experimental Example 4: SEM Measurement (Examination of Deposition Layer)

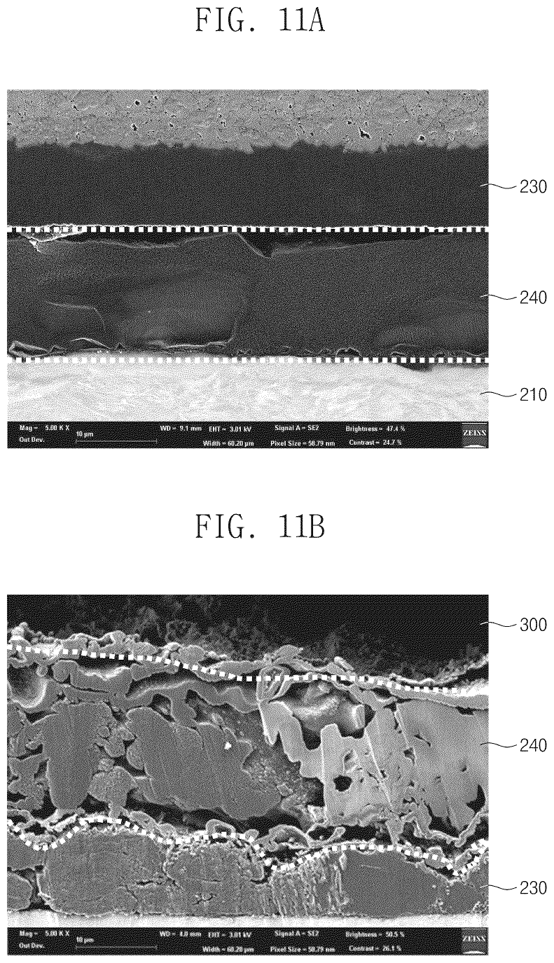

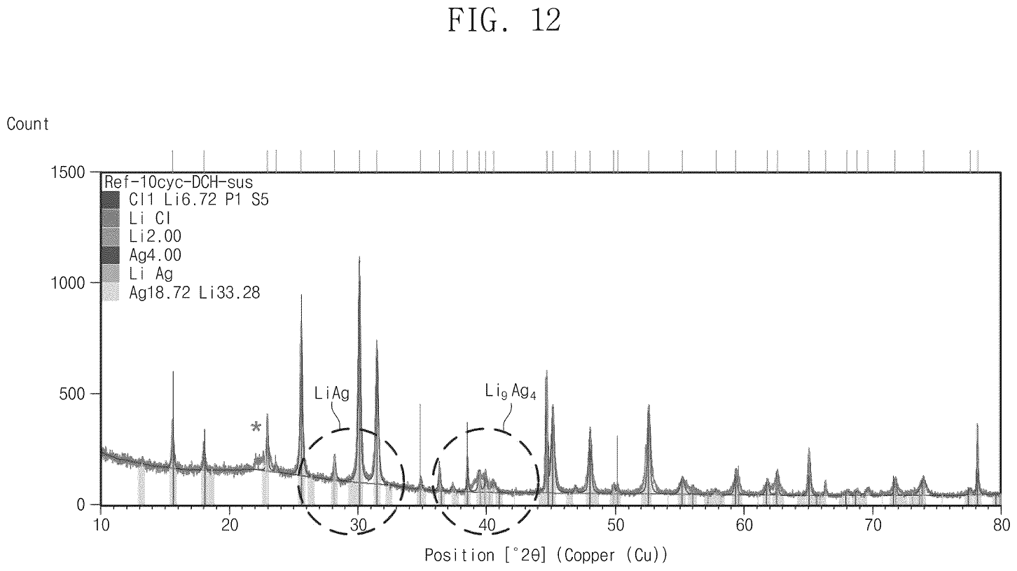

After the capacity evaluation according to Experimental Example 3, a cross-section of the negative electrode of the all-solid-state battery was analyzed utilizing a scanning electron microscope (SEM). FIG. 11A illustrates a SEM image that captures a negative electrode for an all-solid-state battery according to Embodiment 1. FIG. 11B illustrates a SEM image that captures a negative electrode for an all-solid-state battery according to other examples.

Referring to FIG. 11A, it may be observed that the deposition layer 240 was satisfactorily formed between the negative electrode current collector 210 and the functional layer 230. It may be found that lithium metal was uniformly (e.g., substantially uniformly) deposited on the deposition layer 240.

Referring to FIG. 11B, the functional layer 230 was formed between the coating layer 220 and the solid electrolyte layer 300. It may be observed that the deposition layer 240 was formed between the functional layer 230 and the solid electrolyte layer 300. In this case, the deposition layer 240 may show a dendrite structure.

### Experimental Example 5: SEM Measurement (Examination of Deposition Layer)

After performing 10 charge-discharge cycles on the all-solid-state battery according to Embodiment 1, the cell was dissembled, and X-ray diffraction (XRD) analysis was conducted to examine a structure of the negative electrode. FIG. 12 illustrates an XRD analysis result of a negative electrode for an all-solid-state battery according to Embodiment 1. Referring to FIG. 12, it may be observed that a LiAg structure was found in the vicinity of a (28) peak and a Li₉Ag₄ structure was found in the vicinity of a (40) peak. Thus, it may be ascertained that the functional layer included silver (Ag) as a lithiophilic element, which satisfactorily reacted with lithium to form an alloy.

A negative electrode for an all-solid-state battery according to the present disclosure may include a functional layer between a negative electrode current collector and a coating layer. The functional layer may include a lithiophilic metal, and a metal amount of the functional layer may be greater than that of the coating layer. In addition, the thickness of the functional layer in the negative electrode is configured within the range of about 30 nm to about 4 μm to allow lithium metal uniformly being formed on a deposition layer during charge, therefore, the all-solid-state battery including such a negative electrode may improve lifespan characteristics because of the protection from the deposition layer. The presence of the functional layer having high affinity with lithium may cause an improvement in ionic conductivity of lithium ions. Furthermore, the functional layer may induce excellent or suitable electrical conductivity to yield a superior rapid charge. In conclusion, the all-solid-state battery may improve electrical properties and lifespan characteristics.

The battery, a battery management system in the battery, a manufacturing apparatus thereof, or any other relevant apparatuses/devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

In the present disclosure, each suitable feature of the various embodiments of the disclosure may be combined or combined with each other, partially or entirely, and may be technically interlocked and operated in various suitable ways, and each embodiment may be implemented independently of each other or in conjunction with each other in any suitable manner unless otherwise stated or implied.

As used herein, the term “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While the present disclosure has been described in connection with what is presently considered to be one or more embodiments, it is to be understood that the disclosure is not limited to the disclosed embodiments and is intended to cover one or more suitable modifications and equivalent arrangements included within the spirit and scope of the appended claims, and therefore the aforementioned embodiments should be understood to be exemplarily but not limiting the present disclosure in any way.

What is claimed is:

1. A negative electrode comprising:
a negative electrode current collector;
a coating layer comprising carbon and a first metal on the negative electrode current collector; and
a functional layer between the negative electrode current collector and the coating layer,
wherein the functional layer comprises a second metal,
wherein each of the first metal and the second metal comprises at least one lithiophilic element selected from among silver (Ag), gold (Au), magnesium (Mg), indium (In), titanium (Ti), gallium (Ga), platinum (Pt), palladium (Pd), silicon (Si), aluminum (Al), bismuth (Bi), tin (Sn), and zinc (Zn), and
wherein the negative electrode is a negative electrode for an all-solid-state battery.

2. The negative electrode of claim 1, wherein an amount of the second metal in the functional layer is greater than an amount of the first metal in the coating layer.

3. The negative electrode of claim 1, wherein a lithium diffusion coefficient of each of the first metal and the second metal is in a range of about 10⁻¹⁴ cm²/s to about 10⁻⁶ cm²/s.

4. The negative electrode of claim 1, wherein the functional layer comprises a second metal sputter deposited on the negative electrode current collector.

5. The negative electrode of claim 1, wherein the first metal and the second metal are each in a form of particles, and an average particle diameter of the particles of the second metal is less than an average particle diameter of the particles of the first metal.

6. The negative electrode of claim 1, wherein a surface roughness of the functional layer is less than a surface roughness of the coating layer.

7. The negative electrode of claim 1, wherein the functional layer comprises an alloy of the second metal and lithium.

8. The negative electrode of claim 1, wherein a thickness of the coating layer is greater than a thickness of the functional layer.

9. The negative electrode of claim 1, wherein a thickness of the functional layer is in a range of about 30 nm to about 4 μm.

10. The negative electrode of claim 1, further comprising a deposition layer between the negative electrode current collector and the functional layer
wherein the deposition layer comprises an initial charge-discharge cycle deposited lithium.

11. A battery, comprising:
a positive electrode;
a negative electrode opposite to the positive electrode; and
a solid electrolyte between the positive electrode and the negative electrode,
wherein the negative electrode comprises:
a negative electrode current collector;
a coating layer on the negative electrode current collector; and
a functional layer between the negative electrode current collector and
the coating layer,
wherein the coating layer comprises carbon and a first metal,
wherein the functional layer comprises a second metal,
wherein each of the first metal and the second metal is a lithiophilic metal,
wherein a thickness of the coating layer is greater than a thickness of the functional layer,
wherein the thickness of the functional layer is in a range of about 30 nm to about 4 μm, and
wherein the battery is an all-solid-state battery.

12. The battery of claim 11, wherein an average particle diameter of the second metal is less than an average particle diameter of the first metal.

13. The battery of claim 12, wherein each of the first metal and the second metal comprises at least one lithiophilic element selected from among silver (Ag), gold (Au), magnesium (Mg), indium (In), titanium (Ti), gallium (Ga), platinum (Pt), palladium (Pd), silicon (Si), aluminum (Al), bismuth (Bi), tin (Sn), and zinc (Zn).

14. The battery of claim 11, wherein a surface roughness of the functional layer is less than a surface roughness of the coating layer.

15. The battery of claim 11, further comprising a deposition layer between the negative electrode current collector and the functional layer,
wherein the deposition layer comprises an initial charge-discharge cycle deposited lithium.

16. The battery of claim 11, wherein a lithium diffusion coefficient of each of the first metal and the second metal is in a range of about 10⁻¹⁴ cm²/s to about 10⁻⁶ cm²/s.

17. A method comprising:
forming a functional layer on a first surface of a negative electrode current collector; and
forming a coating layer on the functional layer,
wherein the coating layer comprises carbon and a first metal,
wherein the forming of the functional layer comprises performing a sputtering process to form a second metal on the first surface of the negative electrode current collector,
wherein each of the first metal and the second metal comprises at least one lithiophilic element selected from among silver (Ag), gold (Au), magnesium (Mg), indium (In), titanium (Ti), gallium (Ga), platinum (Pt), palladium (Pd), silicon (Si), aluminum (Al), bismuth (Bi), tin (Sn), and zinc (Zn), and
wherein the method is a method for manufacturing an all-solid-state battery.

18. The method of claim 17, wherein the first metal and the second metal are each in a form of particles, and an average particle diameter of the particles of the second metal is less than an average particle diameter of the particles of the first metal.

19. The method of claim 17, wherein an amount of the second metal in the functional layer is greater than an amount of the first metal in the coating layer.

20. The method of claim 17, wherein a surface roughness of the functional layer is less than a surface roughness of the coating layer.
